(19) United States
(12) Patent Application Publication
(10) Pub. No.: US 2025/0255437 A1
(43) Pub. Date: Aug. 14, 2025

(54) STAND MIXER WITH RISING REMOVABLE BOWL

(71) Applicant: Hamilton Beach Brands, Inc., Glen Allen, VA (US)

(72) Inventors: Ben Branson, Glen Allen, VA (US); Matthew Carley, Glen Allen, VA (US)

(73) Assignee: Hamilton Beach Brands, Inc., Glen Allen, VA (US)

(21) Appl. No.: 18/438,070

(22) Filed: Feb. 9, 2024

(51) Int. Cl. A47J 43/07; A47J 43/044

(52) U.S. Cl. CPC A47J 43/0711; A47J 43/0727; A47J 2043/04454

(57) ABSTRACT

A stand mixer includes: a base, the base including a recess; a support arm attached to the base and extending upwardly therefrom; a head attached to an upper end of the support arm and extending generally horizontally therefrom above the recess in the base; and a bowl including a lower skirt configured to mount in the recess of the base. The recess includes one of a plurality of projections and a plurality of indentations; the skirt includes the other of a plurality of projections and a plurality of indentations. The projections and the indentations are disposed generally vertically to allow the skirt to be (a) lowered substantially directly vertically into the recess for mounting, each of the projections being received in a respective indentation, and (b) raised substantially directly vertically from the recess for disengagement.

### FIELD OF THE DISCLOSURE

The present application is directed generally to mixers, and more particularly to stand mixers.

### BACKGROUND

Stand mixers are popular home appliances used for multiple tasks in combining ingredients, such as mixing, creaming, blending, and the like. Stand mixers typically include a base that supports a bowl, an upright support arm that extends upwardly from the base, and a cantilevered “head” that extends horizontally from the upright support on which beaters are mounted. The beaters extend downwardly from the arm into the bowl for use.

Stand mixers typically utilize beaters mounted near the forward end of the head. Ordinarily, the beaters are mounted in the head via a planetary gear arrangement or the like that enables the beaters to thoroughly mix ingredients within the bowl without scraping the sides or the bottom of the bowl; in such an arrangement, each of the beaters rotates about an axis defined by its shaft, plus the pair of beaters revolves together about an axis centered over the bowl. The planetary gear arrangement can be any of those known to those of skill in this art (see, for example, U.S. Pat. No. 5,934,802) and need not be described in detail herein.

While other mechanisms may exist, stand mixers generally employ one of two basic techniques to enable the bowl to be inserted or removed from its position beneath the beaters: tilting heads or bowl lifts. Tilting head mixers typically locate the motor in the head of the mixer and often use lighter components and less powerful motors. The head tilts away from a mixing bowl via a pivoting mechanism to move the beaters into and out of position. An exemplary tilting head stand mixer is Hamilton Beach Model No. 63325, available from Hamilton Beach Brands (Richmond, Va., the present applicant). Bowl lifts move the bowl while the stand mixer head is stationary so that the mixer's beaters are in the bowl when the bowl is lifted.

For tilt head mixers, because the beaters are able to move relative to the bowl and therefore mix contents in all parts of the bowl, the bowl remains stationary relative to the base during mixing. Bowls are usually configured to be secured during mixing, but are able to be dislodged from the base once mixing is complete to enable the mixed foodstuff to be removed, the bowl to be cleaned, and the like. Because removal of the bowl occurs virtually every time the mixer is used, a simple, effective securing arrangement of the bowl to the base may be desirable.

### SUMMARY

As a first aspect, embodiments of the disclosure are directed to a stand mixer comprising: a base, the base including a recess; a support arm attached to the base and extending upwardly therefrom; a head attached to an upper end of the support arm and extending generally horizontally therefrom above the recess in the base; and a bowl including a lower skirt configured to mount in the recess of the base. The recess includes one of a plurality of projections and a plurality of indentations; the skirt includes the other of a plurality of projections and a plurality of indentations. The projections and the indentations are disposed generally vertically to allow the skirt to be (a) lowered substantially directly vertically into the recess for mounting, each of the projections being received in a respective indentation, and (b) raised substantially directly vertically from the recess for disengagement.

As a second aspect, embodiments of the disclosure are directed to a bowl assembly for a stand mixer comprising: a base, the base including a generally recess; a support arm attached to the base and extending upwardly therefrom; a head attached to an upper end of the support arm and extending generally horizontally therefrom above the recess in the base; and a bowl including a generally lower skirt configured to mount in the recess of the base. The recess includes one of a plurality of projections and a plurality of indentations; the skirt includes the other of a plurality of projections and a plurality of indentations. The projections and the indentations are disposed generally vertically to allow the skirt to be lowered substantially directly vertically into the recess for mounting, each of the projections being received in a respective indentation. The projections and indentations are configured to resist rotation of the bowl relative to the base when mounted.

As a third aspect, embodiments of the disclosure are directed to a stand mixer comprising: a base, the base including a recess; a support arm attached to the base and extending upwardly therefrom; a head attached to an upper end of the support arm and extending generally horizontally therefrom above the recess in the base; and a bowl including a lower skirt configured to mount in the recess of the base. The recess includes one of a plurality of projections and a plurality of indentations; the skirt includes the other of a plurality of projections and a plurality of indentations. The projections and the indentations are disposed generally vertically to allow the skirt to be lowered substantially directly vertically into the recess for mounting, each of the projections being received in a respective indentation. A lower edge of the skirt engages a floor of the recess when the bowl is mounted.

### BRIEF DESCRIPTION OF THE FIGURES

FIG. 1 is a perspective view of a stand mixer according to embodiments of the disclosure, with the head tilted to a lowered position.

FIG. 2 is a side view of the stand mixer of FIG. 1, with the head tilted to a raised position and the beater removed.

FIG. 3 is a top perspective view of the bowl of the stand mixer of FIG. 1.

FIG. 4 is a perspective section view of the bowl of FIG. 3 with one beater illustrated.

FIG. 5 is a top perspective view of the skirt of the bowl of FIG. 3.

FIG. 6 is a bottom perspective view of the skirt of the bowl of FIG. 3.

FIG. 7 is a top perspective view of the recess in the base of the stand mixer of FIG. 1.

FIG. 8 is a greatly enlarged partial view of the recess in the base of the stand mixer of FIG. 1.

FIG. 9 is a greatly enlarged section view of the bowl and the recess of the stand mixer of FIG. 1 showing the bowl being lowered into the recess.

### DETAILED DESCRIPTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

Well-known functions or constructions may not be described in detail for brevity and/or clarity.

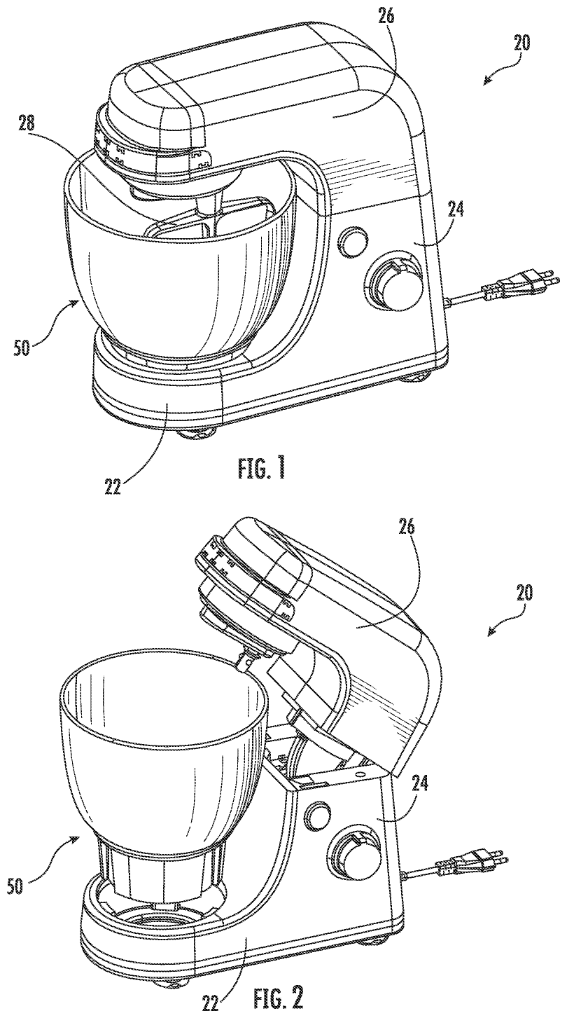

Referring now to the figures, a stand mixer according to embodiments of the disclosure is shown in FIGS. 1-9 and designated broadly at 20. The stand mixer 20 includes a base 22 that rests on an underlying surface, such as a kitchen counter, a vertical support arm 24 that extends upwardly from one end of the base 22, and a head 26 that extends generally horizontally and forwardly from the upper end of the support arm 24. (As used herein, the “forward” or “front” direction is defined by a horizontal vector extending from the support arm 24 toward the opposite end of the base 22. The “rear” direction is opposite the forward direction). The head 26 is pivotally attached to the support arm 24 so that the head 26 can be tilted (i.e., the front end of the head 26 rises) to allow a bowl 50 to be removed from or mounted on the base 22. One or more beaters 28 are mounted near the free end of the head 26 and extend downwardly.

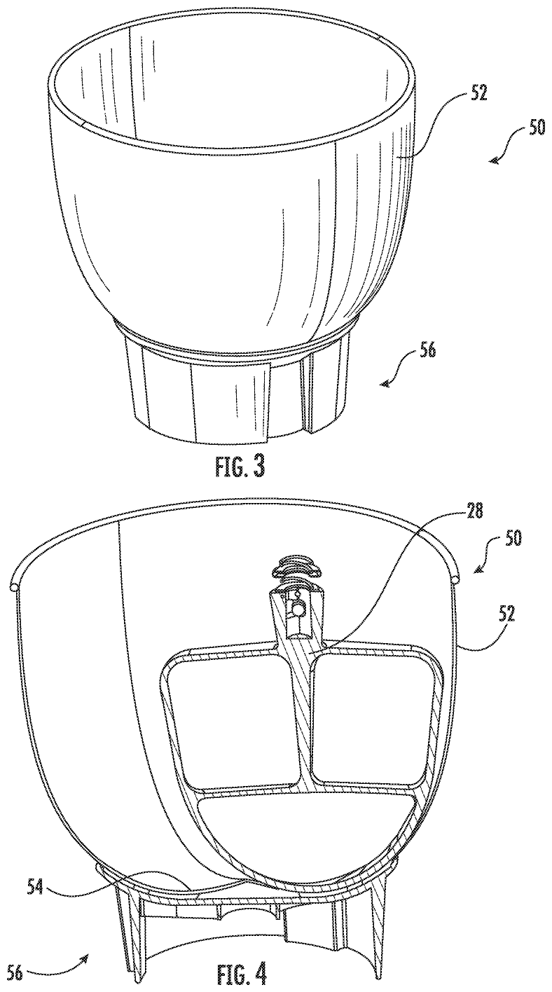

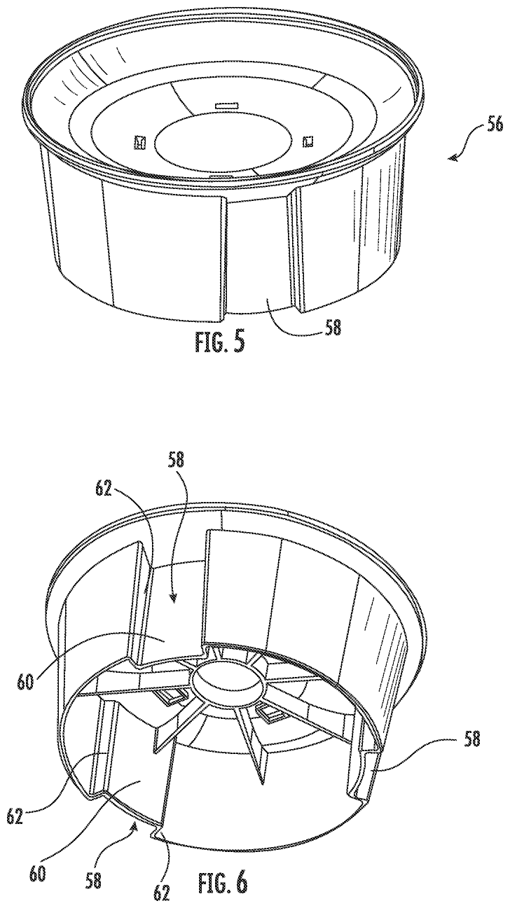

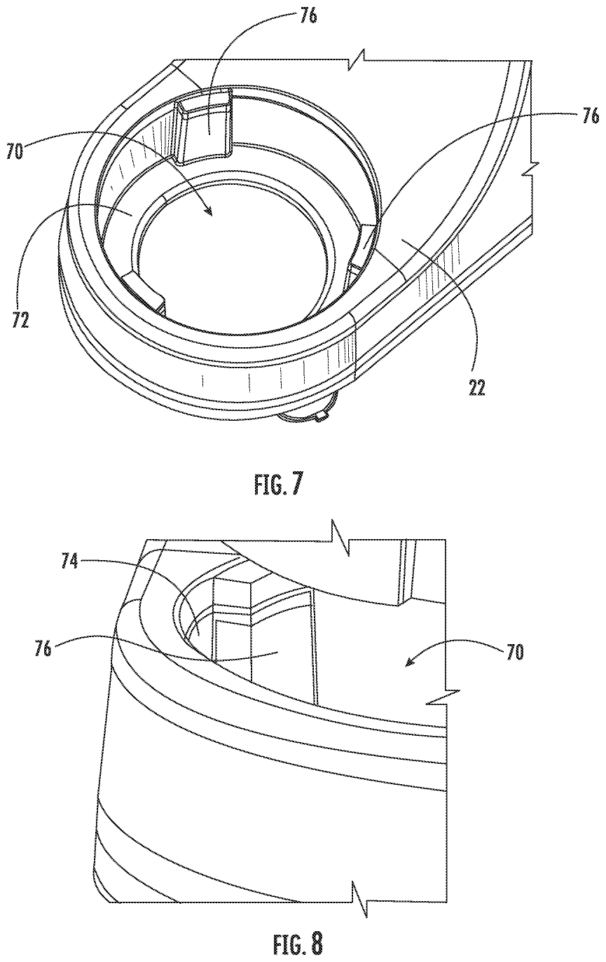

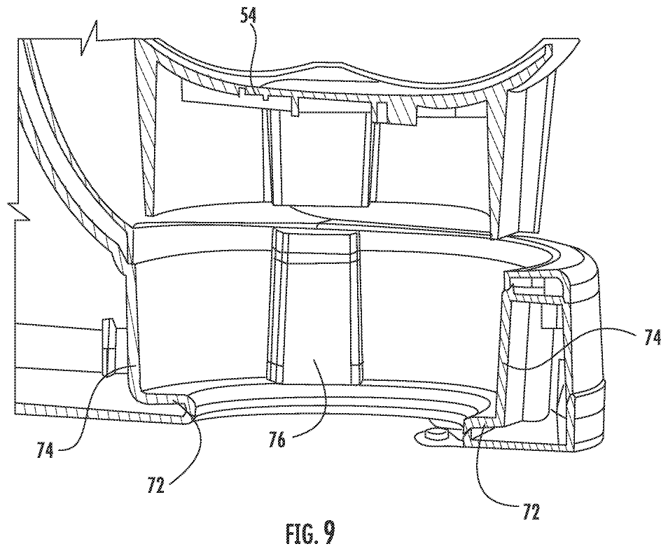

Referring now to FIGS. 3-6, the bowl 50 has a curved side wall 52 that smoothly merges with a scalloped floor 54 (see FIGS. 4 and 8) to define an open-ended mixing space. A generally cylindrical skirt 56 (which may be formed as a separate component) extends downwardly from the floor 54. As shown in FIGS. 5 and 6, the skirt 56 includes three indentations 58 that are generally circumferentially equidistant from each other. Each indentation 58 includes an inner wall 60 and side walls 62. Each of the indentations 58 is slightly tapered, such that it is slightly wider at its lower end than at its upper end; in some embodiments, the taper is such that the side walls 62 are inclined relative to the lower edge of the skirt 56 at an angle of between about 80 and 89 degrees.

Referring now to FIGS. 7 and 8, the base 22 includes a generally cylindrical recess 70 that is sized to receive the skirt 56 of the bowl 50. The recess 70 includes a generally horizontal annular floor 72 and a substantially vertical side wall 74. The diameter of the side wall 74 is typically selected so that the skirt 58 can fit snugly therein. Three projections 76 extend radially inwardly from the side wall 74. The projections 76, which are positioned generally circumferentially from each other, extend from the floor 72 to terminate just below the upper edge of the recess 70. Like the indentations 58, the projections 76 are tapered slightly, such that their lower ends are slightly wider than their upper ends. The depth of the projections 76 (i.e., their radial dimension) is similar to that of the indentations 58.

As can be envisioned by reference to FIGS. 2 and 9, the bowl 50 can be seated/mounted on the base 22 by rotating the bowl 50 about a vertical axis above the recess 70 until the indentations generally align with the projections 76. The bowl 50 can then be lowered so that the skirt 56 is received within the recess 70, with the indentations 58 receiving the projections 76. Because the lower end of each indentation 58 is wider than the upper end of each projection 76, there is some “play” or “float” present that allows the insertion of the projections 76 into the indentations 58 even if the bowl 50 is not perfectly aligned rotationally. The tapering of the indentations 58 and the projections 76 helps to guide the bowl 50 to the correct orientation as the bowl 50 continues to descend. The bowl 50 ceases its downward movement when either the lower edge of the skirt 56 engages the floor 72 of the recess (as is the case with the illustrated embodiment), or the upper edge of the recess 70 engages the lower surface of the bowl 50 or skirt 56.

In this position, it can be seen that the bowl 50 is secured in the base 22, and will not move or rotate when the stand mixer is operated (i.e., when the beaters 30 are rotating); the interaction between the projections 76 of the recess 70 of the base 22 and the indentations 58 of the bowl 50 prevent any relative rotation. In some embodiments, the indentations 58 cover or overlap in the vertical dimension greater than about 35 mm of the projections 76; in some embodiments the indentations may overlap the projections about 45 mm, and even 55 mm in some cases. This amount of overlap can provide sufficient stability to the bowl 50 relative to the base 22 that the bowl 50 does not noticeably shift during operation of the stand mixer 20. In some prior stand mixers, the bowl is secured to the base via bayonet-style rotary action or some other rotational interaction that allows the bowl to be lowered for mounting and raised for removal. However, in some instances (for example, when bread dough or other very viscous foodstuffs are being mixed), the rotational forces generated on the bowl can be sufficient to “overlock” the bowl onto the base, such that the bowl is difficult to dislodge and remove from the base. Because embodiments shown herein do not rely on rotary action to secure the bowl in the base (and in fact resist rotation of the bowl relative to the base), this “overlocking” problem can be avoided.

The bowl 50 can be removed from the base 22 (e.g., for cleaning or removal of mixed foodstuff) by simply lifting the bowl 50 straight upwardly from the base 22.

Both the bowl 50 and the portion of the base 22 that includes the recess 70 are typically formed of a polymeric material. Exemplary materials include acrylonitrile-butadiene-styrene (ABS), polypropylene oxide (PPO), polypropylene (PP) and polycarbonate (PC). However, in other embodiments either or both of the bowl 50 and base 22 may be formed of a different material (e.g., a metallic or ceramic material).

Those of skill in this art will appreciate that the bowl securing technique discussed above may take other forms. For example, there may be more (e.g., four) or fewer (e.g., two) sets of mating indentations and projections. Also, it should be understood that in some embodiments, the locations of the indentations and projections may be reversed, such that the indentations are located in the recess of the base and the projections are located on the skirt of the bowl. Further, in some embodiments, the indentations may lack an inner wall, such that the indentations are simply open spaces that receive the projections. Other variations may also be apparent to those of skill in this art.

Moreover, it is contemplated that the bowl securing system may also be employed with stand mixers, such as those discussed above, that employ a head that rises above the bowl to permit access to the bowl rather than tilting.

Some embodiments of the present invention are exemplarily described above in combination with the accompanying drawings. Those of ordinary skill in the art to which the present invention belongs should understand that specific structures shown in the above embodiments are merely exemplary, rather than limiting. Moreover, those of ordinary skill in the art to which the present invention belongs can combine a variety of technical features shown above according to a variety of possible manners to constitute new technical solutions or make other modifications, and these new technical solutions are encompassed within the scope of the present invention.

That which is claimed is:

1. A stand mixer, comprising:
a base, the base including a recess;
a support arm attached to the base and extending upwardly therefrom;
a head attached to an upper end of the support arm and extending generally horizontally therefrom above the recess in the base; and
a bowl including a lower skirt configured to mount in the recess of the base;
wherein the recess includes one of a plurality of projections and a plurality of indentations;
wherein the skirt includes the other of a plurality of projections and a plurality of indentations;
wherein the projections and the indentations are disposed generally vertically to allow the skirt to be (a) lowered substantially directly vertically into the recess for mounting, each of the projections being received in a respective indentation, and (b) raised substantially directly vertically from the recess for disengagement.

2. The stand mixer defined in claim 1, wherein the indentations are located on the skirt and the projections are located on the base.

3. The stand mixer defined in claim 1, wherein the indentations are tapered to narrow from a lower end to an upper end.

4. The stand mixer defined in claim 1, wherein the projections are tapered to narrow from a lower end to an upper end.

5. The stand mixer defined in claim 1, wherein when the bowl is mounted on the base, at least 35 mm of vertical overlap is present between the indentations and the projections.

6. The stand mixer defined in claim 5, wherein at least 45 mm of vertical overlap is present.

7. The stand mixer defined in claim 1, wherein the head is pivotally attached to the support arm.

8. The stand mixer defined in claim 1, wherein the projections are spaced substantially equidistantly around the recess.

9. A stand mixer, comprising:
a base, the base including a generally recess;
a support arm attached to the base and extending upwardly therefrom;
a head attached to an upper end of the support arm and extending generally horizontally therefrom above the recess in the base; and
a bowl including a generally lower skirt configured to mount in the recess of the base;
wherein the recess includes one of a plurality of projections and a plurality of indentations;
wherein the skirt includes the other of a plurality of projections and a plurality of indentations;
wherein the projections and the indentations are disposed generally vertically to allow the skirt to be lowered substantially directly vertically into the recess for mounting, each of the projections being received in a respective indentation; and
wherein the projections and indentations are configured to resist rotation of the bowl relative to the base when mounted.

10. The stand mixer defined in claim 9, wherein the indentations are located on the skirt and the projections are located on the base.

11. The stand mixer defined in claim 9, wherein the indentations are tapered to narrow from a lower end to an upper end.

12. The stand mixer defined in claim 9, wherein the projections are tapered to narrow from a lower end to an upper end.

13. The stand mixer defined in claim 9, wherein when the bowl is mounted on the base, at least 35 mm of vertical overlap is present between the indentations and the projections.

14. The stand mixer defined in claim 13, wherein at least 45 mm of vertical overlap is present.

15. The stand mixer defined in claim 9, wherein the head is pivotally attached to the support arm.

16. The stand mixer defined in claim 9, wherein the projections are spaced substantially equidistantly around the recess.

17. A stand mixer, comprising:
a base, the base including a recess;
a support arm attached to the base and extending upwardly therefrom;
a head attached to an upper end of the support arm and extending generally horizontally therefrom above the recess in the base; and
a bowl including a lower skirt configured to mount in the recess of the base;
wherein the recess includes one of a plurality of projections and a plurality of indentations;
wherein the skirt includes the other of a plurality of projections and a plurality of indentations;
wherein the projections and the indentations are disposed generally vertically to allow the skirt to be lowered substantially directly vertically into the recess for mounting, each of the projections being received in a respective indentation, and wherein a lower edge of the skirt engages a floor of the recess when the bowl is mounted.

18. The stand mixer defined in claim 17, wherein when the bowl is mounted on the base, at least 35 mm of vertical overlap is present between the indentations and the projections.

19. The stand mixer defined in claim 18, wherein at least 45 mm of vertical overlap is present.

20. The stand mixer defined in claim 18, wherein the projections are spaced substantially equidistantly around the recess.
